(19) United States
(12) Patent Application Publication
(10) Pub. No.: US 2002/0091820 A1
(43) Pub. Date: Jul. 11, 2002

(54) Web audience analyzing method, computer program product, and web audience analysis system

(76) Inventor: Jun Hirai, Fuchu-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/915,346

(22) Filed: Jul. 27, 2001

(30) Foreign Application Priority Data
Jul. 28, 2000 (JP) 2000-229164
Jul. 19, 2001 (JP) 2001-220331

(51) Int. Cl. G06F 15/173

(52) U.S. Cl. 709/224

(57) ABSTRACT

There is disclosed a Web audience analyzing method for analyzing an audience of a Web page assembly constituted of at least one Web page by a computer, comprising the steps of acquiring related information including a designation of a Web page assembly related to the Web page assembly as an analysis object, acquiring audience information with respect to the Web page assembly designated by the related information, and executing an analysis processing based on the acquired audience information and obtaining evaluation information concerning the analysis object Web page assembly.

### CROSS-REFERENCE TO RELATED APPLICATIONS

This application is based upon and claims the benefit of priority from the prior Japanese Patent Applications No. 2000-229164, filed Jul. 28, 2000; and No. 2001-220331, filed Jul. 19, 2001, the entire contents of both of which are incorporated herein by reference.

### BACKGROUND OF THE INVENTION

1. Field of the Invention

The present invention relates to a Web audience analyzing method, computer program product, and Web audience analysis system for evaluating/improving a Web page and an assembly (e.g., a Web site, a virtual shop on WWW, and the like) of a plurality of Web pages in a World Wide Web (WWW), and effectively utilizing the WWW for a commercial purpose.

2. Description of the Related Art

The following three types of techniques are utilized to measure a degree of recognition with respect to a Web page, or an assembly of a plurality of Web pages such as a Web site. Additionally, the Web page is generally a unit of Web information indicated by one URL. Moreover, the Web site is generally a unit of Web information indicated by one domain name. The Web page as an analysis unit will be described hereinafter. However, the following also applies to a case in which the analysis unit is the assembly of a plurality of Web pages.

(1) Analysis of Access Log on Web Server and Collection of Questionnaire

In this technique, analysis is performed based on information able to be collected in a Web server in which the Web page is opened to the public via a network.

An access log can be recorded in the Web server. When the recorded access logs are totaled/analyzed, the number of accesses, and the number of accesses per browser are measured.

Furthermore, a questionnaire survey is conducted on the Web server, an question with an arbitrary content is addressed to an audience, and an answer can be obtained from the audience.

(2) Analysis of Hyperlink Structure between Web Pages

In this technique, a structure of a hyperlink extended between Web pages is analyzed, and popularity and recognition of the pages are measured.

Merits of the technique lie in that it is unnecessary to prepare a mechanism for collecting information for analysis in each Web page and the Web server for providing the page, and it is also unnecessary to gather panel members who provide characteristic information and information of the accessed Web page.

(3) Web Audience Rating Survey

In this technique, a Web browser and Web page browsed by the browser are surveyed. Additionally, browsing herein means that a person uses the Web browser mounted on a personal computer, mobile terminal, phone, or another information apparatus to access the Web page. A Web audience rating survey will concretely be described hereinafter.

A Web audience rating surveyor (Web audience rating survey company) recruits panel members who have a will to provide information, and installs a special information collecting module on the Web browser used by the panel member.

Moreover, the Web audience rating surveyor holds the characteristic information of the panel member such as sex, job type, age group, income band, family members, and residence area.

Every time the panel member browses various Web pages, the information collecting module transmits URL and panel member ID to an information collecting server of the Web audience rating surveyor.

The information collecting server gathers the collected URLs for each Web page, adds up the number of browsing times of the Web page, and obtains characteristics (sex, age, annual income, and the like) of a browsing person by an analysis processing (e.g., statistical processing, totaling processing, and the like) based on the characteristic information concerning the registered panel member.

Thereby, the audience rating of the Web page can be ranked in order. The audience rating surveyor sells an analysis result of the Web page to a corporation which utilizes the Web page to do business.

The merits of this technique lie in that the information collecting module for collecting the information such as an URL to be accessed is installed in the Web browser to perform the rating survey, and it is therefore unnecessary to functionally change the browsed Web page and the Web server providing the page.

Moreover, when this technique is utilized, it is possible to compare the Web pages at the same standard, and obtain a ratio in the whole audience rating. Furthermore, it is also possible to collect information indicating a dynamic flow in a case in which the Web browser moves among a plurality of Web pages to be browsed.

Furthermore, due consideration is usually paid in selecting the panel member, and the panel member is sampled so that an epitome of all Internet users is obtained. Therefore, the result of analysis of the panel member has a high reliability as compared with a result of the questionnaire survey.

In an actual store, if there are any visitors or potential customers walking around the store, it is possible to obtain sex, age group and other characteristics simply by observing appearances of those people.

However, in the virtual shop on WWW in electronic commerce (EC), even with any audience of virtual store information, unless the audience answers the questionnaire or positively provides information through means such as registration into a customer registration mechanism prepared by the virtual store, it is difficult to obtain the characteristic of the audience.

Moreover, it is assumed that the Web audience rating information obtained by a conventional Web audience rating survey is utilized to obtain the audience characteristic. In this case, when the number of those who have browsed the Web page as an analysis object is not enough, a sufficient amount of information for the analysis processing in the Web audience rating survey cannot be obtained. Thus, There is a problem that a significant analysis result cannot be derived by a statistical processing.

That is, if the Web page is famous, it is possible to collect the sufficient amount of information for analyzing the audience characteristic by the Web audience rating survey. However, the amount of collected information is excessively small with respect to the Web page having a medium, small or less scale, and it is difficult to analyze the audience characteristic.

To solve the problem, the number of panel members may be increased so that the sufficient amount of information for performing the analysis processing of each Web page can be collected.

However, the increasing of the number of panel members is not efficiency, for example, because it is difficult to secure the panel members. Even if the number of panel members is increased, the information sufficient for statistical analysis cannot sometimes be obtained.

When the access log on the aforementioned Web server is analyzed, and questionnaire results are collected, the content of the Web page needs to be changed in order to perform the questionnaire survey on the Web server. Moreover, it is necessary to change a function so that Cookie is transmitted in order to specify a unique browser. Furthermore, a questionnaire respondent does not appropriately reflect a whole image of the audience of the analysis object Web page in some case. Additionally, it is difficult to compare and analyze the Web page with a large number of other Web pages not opened to the public on the Web server at the same standard.

Moreover, in the conventional Web audience rating survey, even if a sufficient amount of information is collected with respect to the analysis object Web page, only the information of a person having actually browsed the Web page can be grasped. Information of a potential audience having a high probability of browsing the analysis object Web page in future cannot be grasped, and this raises a problem that the content of the analysis is limited.

When the corporation commercially utilizing the Web page can obtain not only the information of the person actually having browsed the corresponding Web page but also the characteristic of the potential audience, the characteristic can be utilized for various purposes.

For example, it is assumed that as a result of the analysis the audience of the Web page includes a large number of young males at present, but the potential audience includes a considerable number of aged females. In this case, an article sales strategy planned only based on the result indicating a large number of young males is compared with the article sales strategy planned based on the result indicating an increasing number of aged females in addition to the young males. As a result, when the latter strategy is employed, more articles can be expected to be sold.

However, only the information of an event of the person actually having browsed the analysis object Web page can be obtained from the result of the conventional Web audience rating survey, and it is difficult to also obtain the information concerning the aforementioned potential audience.

### BRIEF SUMMARY OF THE INVENTION

An object of the present invention is to provide a Web audience analyzing method, computer program product, and Web audience analysis system which can estimate audience characteristics even with a small number of audiences of a Web page as an analysis object, and which can effectively analyze a potential audience as well.

According to a first aspect of the present invention, there is provided a Web audience analyzing method for analyzing an audience of a Web page assembly constituted of at least one Web page by a computer, the method comprising the steps of: acquiring related information including a designation of the Web page assembly related to the Web page assembly as an analysis object; acquiring audience information with respect to the Web page assembly designated by the related information; and executing an analysis processing based on the acquired audience information and obtaining evaluation information concerning the analysis object Web page assembly.

In the first aspect of the present invention, the audience information concerning the Web page assembly having a predetermined relation with the analysis object Web page assembly is analyzed, and an analysis result is treated as the evaluation information concerning the analysis object Web page assembly.

That is, in the first aspect of the present invention, based on an assumption that the audience characteristic of the analysis object Web page assembly is similar to the audience characteristic of the Web page related to the analysis object Web page assembly, the analysis result of the latter is treated as the evaluation information of the former.

Even when the number of panel audiences of the analysis object Web page assembly is small and it is difficult to obtain the audience characteristic based on a statistical processing, it is possible to obtain the audience characteristic of the related Web page assembly based on the statistical processing with a sufficiently large number of panel audiences of the related Web page assembly.

Therefore, even when the number of panel audiences is small with respect to the analysis object Web page assembly, the evaluation information can be used to effectively evaluate and improve the analysis object Web page assembly.

Moreover, since the audience tends to successively browse the related Web page assembly in WWW, the evaluation information can be estimated as information of a potential audience of the analysis object Web page assembly.

Therefore, when the first aspect of the present invention is utilized, the potential audience can effectively be analyzed, and a high-degree marketing can be performed in EC.

Moreover, when the first aspect of the present invention is utilized, commercial utilization of WWW can be advanced.

According to a second aspect of the present invention, there is provided a Web audience analyzing method comprising the steps of: inputting a designation of a Web page assembly as an analysis object; acquiring related information including a designation of a Web page assembly related to the analysis object Web page assembly based on the designation of the analysis object Web page assembly; acquiring audience information with respect to the Web page assembly designated by the related information; executing an analysis processing based on the acquired audience information; and providing evaluation information concerning the analysis object Web page assembly as a result of the analysis processing.

When the second aspect of the present invention is carried out, there can be provided an evaluation service even with a small number of audiences, and a service of obtaining a characteristic of a potential audience with respect to the analysis object Web page assembly.

Additionally, the designation of the analysis object Web page assembly may be inputted from a survey requesting person via a network. Moreover, the evaluation information may be presented to the survey requesting person via the network, as a report, or a written recording medium.

According to a third aspect of the present invention, there is provided a computer readable computer program product for analyzing an audience of a Web page assembly. The program product comprises: a first code that acquires related information including a designation of a Web page assembly related to the Web page assembly as an analysis object; a second code that acquires audience information with respect to the Web page assembly designated by the related information; and a third code that executes an analysis processing based on the acquired audience information and obtains evaluation information concerning the analysis object Web page assembly.

According to a fourth aspect of the present invention, there is provided a computer program product comprising: a first code that inputs a designation of a Web page assembly as an analysis object; a second code that acquires related information including a designation of a Web page assembly related to the analysis object Web page assembly based on the inputted designation of the analysis object Web page assembly; a third code that acquires audience information with respect to the Web page assembly designated by the acquired related information; a fourth code that executes an analysis processing based on the acquired audience information; and a fifth code that provides evaluation information concerning the analysis object Web page assembly as a result of the analysis processing.

When the computer program products according to the third and fourth aspects of the present invention are used, functions can easily be added even to a computer or a computer system not having functions realized by the aforementioned respective program codes.

Moreover, when the third and fourth aspects of the present invention are utilized, similar effects can be obtained by actions similar to those of the first and second aspects of the present invention.

According to a fifth aspect of the present invention, there is provided a Web audience analysis system for analyzing an audience of a Web page assembly, comprising: a related information acquiring section that acquires related information including a designation of at least one Web page assembly related to the Web page assembly as an analysis object; an audience information acquiring section that acquires audience information with respect to the Web page assembly designated by the related information acquired by the related information acquiring section; and an analysis processor that executes an analysis processing based on the audience information acquired by the audience information acquiring section and obtains evaluation information concerning the analysis object Web page assembly.

According to a sixth aspect of the present invention, there is provided a Web audience analysis system comprising: an input section that inputs a designation of a Web page assembly as an analysis object; a related information acquiring section that acquires related information including a designation of a Web page assembly related to the analysis object Web page assembly based on the designation of the analysis object Web page assembly inputted by the input section; an audience information acquiring section that acquires audience information with respect to the Web page assembly designated by the related information acquired by the related information acquiring section; an analysis processor that executes an analysis processing based on the audience information acquired by the audience information acquiring section; and a result notifying function that provides evaluation information concerning the analysis object Web page assembly as a result of the analysis processing by the analysis processor.

When the fifth and sixth aspects of the present invention are utilized, similar effects can be obtained by actions similar to those of the first and second aspects of the present invention.

In the aforementioned respective aspects of the present invention, for example, for the related information, the Web page assembly related to the analysis object Web page assembly is selected from Web page assemblies present on a network, and the related information is generated based on the designation of the selected Web page assembly.

Furthermore, in the respective aspects of the present invention, for example, the audience information is generated based on audience characteristic information and a record of the Web page assembly browsed by the audience.

Additionally, in the respective aspects of the present invention, for example, the related information may include the designation of a Web page assembly linked with the analysis object Web page assembly in a predetermined relation.

In WWW, the audience often traces a link and transits among the Web page assemblies.

Therefore, an audience of the Web page assembly linked with the analysis object Web page assembly in the predetermined relation has a high probability of becoming the audience of the analysis object Web page assembly.

Consequently, even when the number of panel audiences is small with respect to the analysis object Web page assembly, the Web page assembly can effectively be evaluated/improved by analyzing the Web page assembly linked with the analysis object Web page assembly in the predetermined relation.

Moreover, the evaluation information as the analysis result can be estimated as a characteristic of a potential audience of the analysis object Web page assembly.

Furthermore, in the respective aspects of the present invention, for example, the related information may include a designation of the Web page assembly as a linker (a source page of the hyperlink) of the analysis object Web page assembly.

Because an audience of the linker Web page assembly of the analysis object Web page assembly has a high probability of browsing the analysis object Web page assembly.

Additionally, a link and a hyperlink have the identical concept in this description, and it is defined that a linker (a source page of the link) is a Web page assembly which has a hyperlink pointing a certain Web page assembly as a standard. That is, the linker Web page assembly is a referrer Web page assembly which extends the hyperlink to the certain Web page assembly to refer to the assembly.

Moreover, in the respective aspects of the present invention, for example, the related information may include a designation of a Web page assembly having a linker common with the linker of the analysis object Web page assembly.

When the linker Web page assembly is common among a plurality of Web page assemblies, the audience of one Web page assembly has a strong tendency to also become the audience of the other Web page assembly.

Furthermore, in the respective aspects of the present invention, for example, for the related information, the Web page assembly as the linker of the analysis object Web page assembly is obtained based on referrer information as information indicating the linker of a Web page accessed utilizing the link, and the related information may be generated based on the designation of the obtained Web page assembly.

When the referrer information is utilized, the related information can efficiently and easily be generated. Moreover, since the designation of the actual linker Web page assembly of the analysis object Web page assembly is included in the related information, a higher precision analysis can be performed.

Furthermore, in the respective aspects of the present invention, for example, in the analysis processing, the number of accesses to the analysis object Web page assembly from the Web page assembly designated by the related information utilizing the link is obtained for each Web page assembly designated by the related information based on the referrer information, and the audience information may be weighted in accordance with the number of accesses.

Thereby, since the audience is analyzed in accordance with the number of audiences actually having utilized the link to access the analysis object Web page assembly, precision of estimation of a potential audience characteristic can be enhanced.

Additionally, in the respective aspects of the present invention, for example, in the analysis processing, the number of users who have accessed the analysis object Web page assembly from the Web page assembly designated by the related information utilizing the link is obtained for each Web page assembly designated by the related information based on user identifying information sent from a user terminal for accessing a Web server, and the referrer information. Then, the audience information may be weighted in accordance with the number of users.

Moreover, examples of the user identifying information include IP address information of the terminal operated by the user stored in the Web server, and cookie or another information exchanged between the Web browser and the Web server.

Therefore, even when there are a plurality of accesses from the same user, the same terminal, and the same browser, these accesses can be analyzed as one access.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently embodiments of the invention, and together with the general description given above and the detailed description of the embodiments given below, serve to explain the principles of the invention.

FIG. 1 is a block diagram showing a constitution example of a Web audience analysis system according to a first embodiment of the present invention.

FIG. 2 is a diagram showing a link relation between a Web page as an analysis object and a linker Web page.

FIG. 3 is a diagram showing a reverse link relation between the Web page as then analysis object and the linker Web page.

FIG. 4 is a flowchart showing a Web audience analyzing method in the first embodiment.

FIG. 5 is a block diagram showing a constitution example of an access log collection system.

FIG. 6 is a diagram showing a constitution of an accessed URL notification message.

FIG. 7 is a diagram showing a first link relation of a Web page related to the analysis object Web page.

FIG. 8 is a diagram showing a second link relation of the Web page related to the analysis object Web page.

FIG. 9 is an explanatory view of weighting in accordance with a frequency of referrer information.

FIG. 10 is a block diagram showing a recording medium in which a Web audience analysis program is recorded.

FIG. 11 is a block diagram showing a service providing state by the Web audience analysis system according to a fifth embodiment of the present invention.

FIG. 12 is a flowchart showing a processing executed by the Web audience analysis system which provides a Web audience analysis service.

### DETAILED DESCRIPTION OF THE INVENTION

Respective embodiments of the present invention will be described hereinafter with reference to the drawings. In the respective embodiments, to simplify description, an example in which each Web page assembly is a single Web page unit will be described. However, the number of Web pages constituting each Web page assembly can be arbitrary in the present invention.

For example, a certain Web page assembly may be constituted of one Web page on a certain Web site. Here, the Web site is a computer operated as an independent domain, or an organization which operates the computer. The Web site is designated by a domain name represented, for example, in the form of “www.abcde.co.jp”.

On the other hand, one Web page assembly may be constituted of all Web pages included in the Web site.

Additionally, the Web page assembly may be constituted of a plurality of Web pages like a virtual shop of a shopping mall on a network, but a scale of the assembly is not so large as that of the Web site.

Moreover, the Web page assembly may be a Web page provided by an individual. The Web page provided by the individual is usually constituted of a home page designated by an address represented, for example, in the form of www.abcde.co.jp/fgh, and a plurality of Web pages traceable from the home page via a hyperlink.

A meaning of the Web page assembly in the respective embodiments may be any one of the aforementioned meanings, or any combination of the meanings.

(First Embodiment)

A Web page which is related to a Web page as an analysis object desired to be analyzed is defined as a related page.

When a structure of a hyperlink extended between the Web pages is analyzed, it is possible to obtain a linker Web page (i.e., a linker Web page with respect to the Web page as the analysis object) which has hyperlinks pointing the Web page as the analysis object. The obtained linker Web page can be treated as the related page.

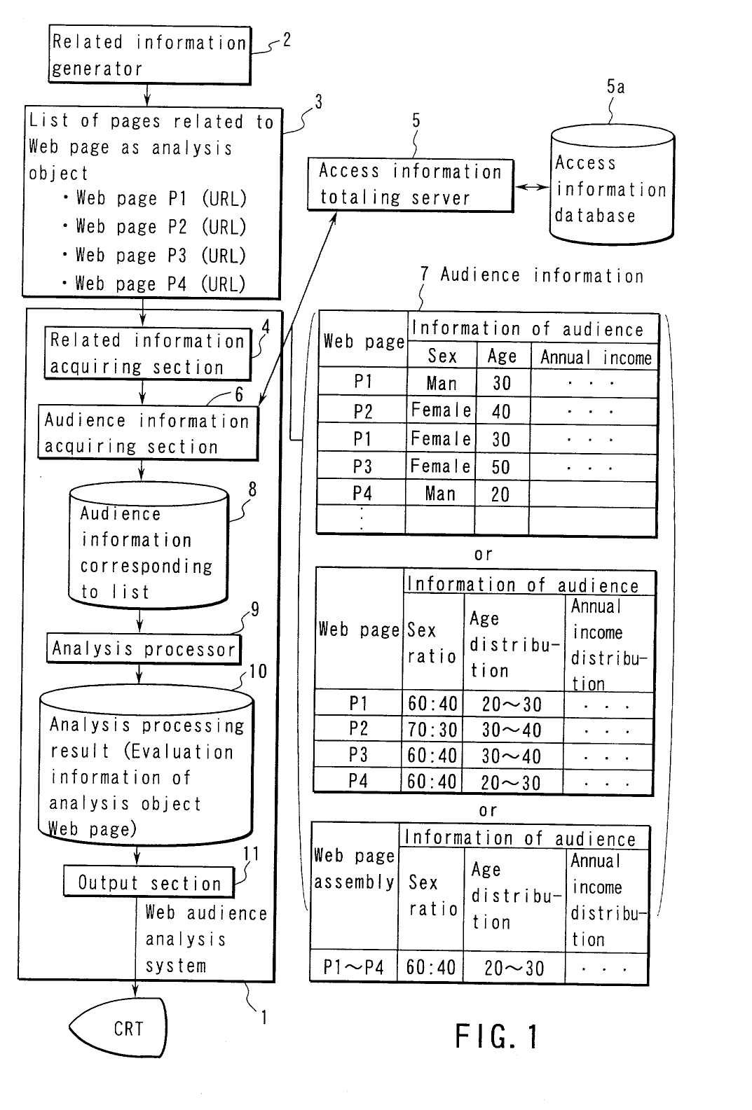

FIG. 1 is a block diagram showing a constitution example of a Web audience analysis system according to a first embodiment.

A Web audience analysis system 1 according to the first embodiment obtains a related page list (related information) 3 generated by a related information generator 2 via a related information acquiring section 4.

Moreover, the Web audience analysis system 1 refers to an access information totaling server 5 including an access information database 5a via an audience information acquiring section 6, obtains audience information 7 with respect to the related page designated by the list 3, and stores the information in a disk 8.

Moreover, the Web audience analysis system 1 executes various analysis processings by an analysis processor 9 based on a stored content of the disk 8, stores a result of the analysis processing as evaluation information with respect to the Web page as the analysis object in a disk 10, and outputs the stored content of the disk 10 via an output section 11 if necessary.

In the list 3, for example, URL of the related page designated by a link reverse from the Web page as the analysis object by one hop is described.

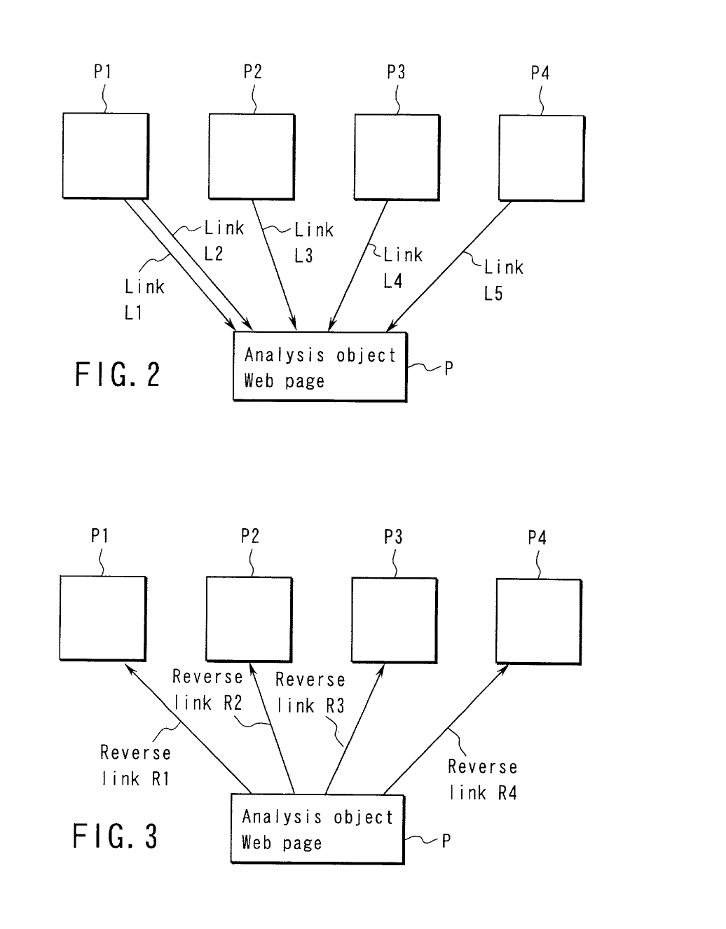

FIG. 2 is a diagram showing a link relation between the Web page as the analysis object and a linker Web page.

Web pages P, P1 to P4 have contents described, for example, in HTML. Moreover, links L1 to L5 are, for example, hyperlinks described in HTML.

In FIG. 2, the links L1 to L5 are extended to the analysis object Web page P from the Web pages P1 to P4.

In this invention, a Web page which has a hyperlink pointing the other web page is called linker of the latter one. Thus, in FIG. 2, Web pages P1 to P4 are the linkers of Web page P.

FIG. 3 is a diagram showing a reverse link relation between the analysis object Web page P and the linker Web pages P1 to P4.

Reverse links R1 to R4 are virtual links directed in reverse to the links extended between the Web pages.

The related information generator 2 collects the Web page on WWW, analyzes a link structure, obtains the reverse links with respect to the respective Web pages on WWW, and selects the reverse link whose start point is the analysis object Web page P. For example, when the link to the Web page as the analysis object from a certain Web page is found, the reverse link to the Web page from the Web page as the analysis object is found.

The linker Web page to the Web page as the analysis object is a Web page connected to the Web page as the analysis object via the reverse link. The related information generator 2 regards the linker Web page to the Web page as the analysis object, and described URL of the related page in the list 3.

In the access information database 5a, audience characteristic information, and access log indicating the Web page browsed by the audience and browsing time are stored.

Upon receiving an information acquiring request from the audience information acquiring section 6, the access information totaling server 5 refers to the access information database 5a, generates the audience information 7 in accordance with the information acquiring request, and transmits the generated audience information 7 to the audience information acquiring section 6.

Concrete examples of the audience information 7 transmitted to the audience information acquiring section 6 from the access information totaling server 5 include audience characteristic information (e.g., audience sex, age, annual income, and the like) of each Web page designated in the list. Another example of the audience information 7 is a result (sex ratio, age distribution, annual income distribution) of the audience characteristic information totaled for each Web page by the access information totaling server 5. Further example of the audience information 7 is a result of the audience characteristic information totaled for each Web page assembly.

A Web audience analyzing method performed by the Web audience analysis system 1 constituted as described above will be described hereinafter.

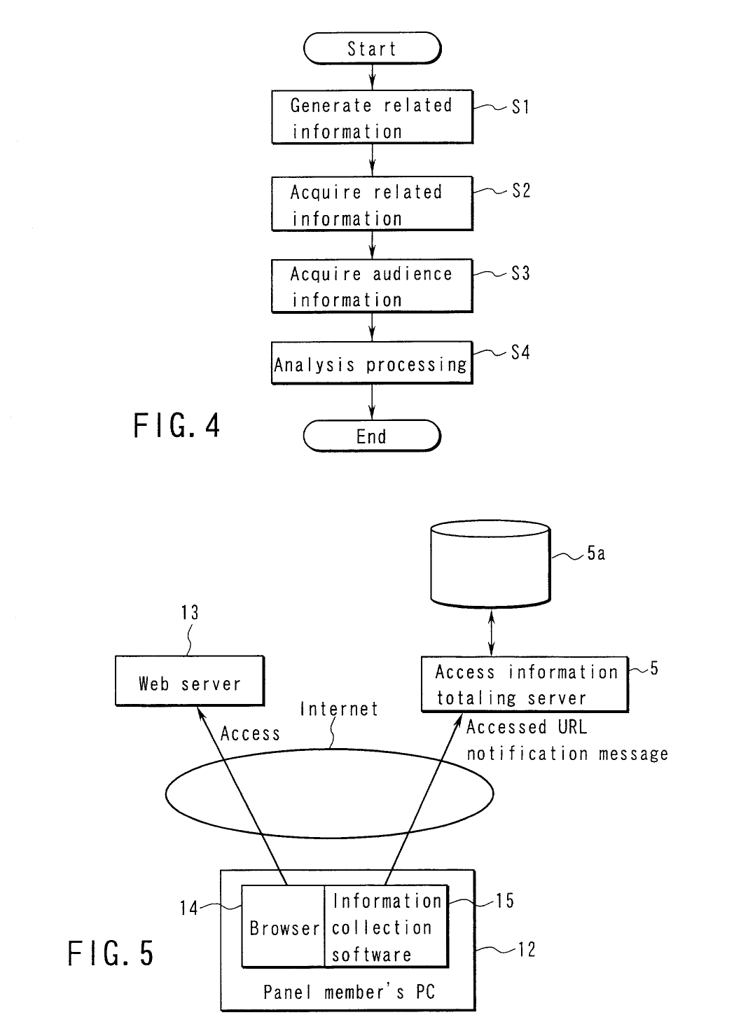

FIG. 4 is a flowchart showing the Web audience analyzing method.

First, the Web page on WWW is automatically collected by a technique utilized by a search engine in order to generate the related page list 3.

A system generally called crawler, spider, robot, or the like is utilized for automatic collection of the Web page. An operation of the system named in this manner will be described hereinafter.

First, a person gives URL of the arbitrary Web page as a seeds to the crawler. The crawler acquires the content of the Web page designated by the URL given as the seeds by an HTTP protocol.

Then, the crawler acquires the URL of another Web page designated by the hyperlink from the obtained content of the Web page, acquires the content of the another Web page designated by the URL, and repeats this processing. When an appropriate seeds is given to the crawler, the sufficient URL of the Web page on WWW is automatically collected.

Additionally, in the automatic collection of the URL by the crawler, the URL of a non-linked Web page is not found in principle as long as the URL is not given as the seeds by the person. However, if the person manually gives the URL to the crawler or utilizes means other than the automatic collection, the URL of the not-linked Web page can also be acquired. Moreover, the non-linked Web page generally has a small number of audiences. Therefore, even when the Web page URL is not acquired, an influence exerted upon the analysis result is expected to be small.

When the Web page is collected by the crawler, the content of the collected Web page is analyzed, and reverse link information between the Web pages is obtained. The operation of the system named as described above will be described hereinafter.

First, the content of the Web page collected by the crawler is analyzed, and information of a pair of Web pages connected to each other via the hyperlink is obtained.

Table 1 is a link URL table indicating the pair of Web pages connected to each other via the hyperlink.

TABLE 1
Link URL Table

| Linker URL | Linked URL |
|---|---|
| www.page1.co.jp | www.page100.co.jp |
| www.page1.co.jp | www.page101.co.jp |
| www.page1.co.jp | www.page102.co.jp |
| www.page2.co.jp | www.page100.co.jp |
| www.page110.co.jp | www.page101.co.jp |

The URL of the Web page collected by the crawler is disposed in a row of a linker URL of Table 2, and the URL of the Web page designated by the hyperlink from the Web page is disposed in a row of a linked URL.

That is, in Table 1, one pair of the linker URL and linked URL is disposed in one line.

When there are a plurality of hyperlinks to the linked Web page from the linker Web page, there are a plurality of the same pairs of the linker URL and linked URL, but in Table 1 these same pairs are collectively shown as one.

Subsequently, the URL of a character string is converted to a numeric page.

Table 2 is a URL-page ID conversion table, and shows a correspondence between the URL and the page ID. The URL has a one-to-one correspondence with the page ID.

TABLE 2
URL-Page ID Conversion Table

| URL | Page ID |
|---|---|
| www.page1.co.jp | 0 |
| www.page2.co.jp | 1 |
| www.page100.co.jp | 2 |
| www.page101.co.jp | 3 |
| www.page102.co.jp | 4 |
| www.page110.co.jp | 5 |

Table 2 is prepared, for example, by acquiring all URL from Table 1 of the link URL table, sorting the URL in an alphabetical order, gathering the same URLs, and allotting integers to URL lists in order. Each integer allotted to each URL indicates each page ID.

Table 2 is utilized to obtain the corresponding page ID from the URL. Conversely, the table is also utilized to obtain the corresponding URL from the page ID.

Table 3 is a link page ID table indicating a pair of page IDs of the Web pages connected to each other via the hyperlink.

TABLE 3
Link Page ID Table

| Linker page ID | Linked page ID |
|---|---|
| 0 | 2 |
| 0 | 3 |
| 0 | 4 |
| 1 | 2 |
| 5 | 3 |

Table 3 is prepared by replacing the URL of Table 1 with the page ID based on the content of Table 2.

A reverse link page ID table in Table 4 is a table a pair of the ID and a reverse link page ID pointed from the page by the reverse link.

TABLE 4
Reverse link page ID table

| Page ID | Reverse link page ID |
|---|---|
| 2 | 0 |
| 2 | 1 |
| 3 | 5 |
| 3 | 0 |
| 4 | 0 |

Table 4 is prepared by disposing a value of the linked page ID in Table 3 in a row of page ID, disposing a value of the linker page ID in Table 3 in a row of reverse link page ID, and sorting respective lines by the page ID value.

Table 5 is a reverse link page ID list table in which reverse link page IDs are collected for each page ID.

TABLE 5
Reverse link page ID list table

| Page ID | Reverse link page ID list |
|---|---|
| 2 | 0, 1 |
| 3 | 0, 5 |
| 4 | 0 |

Table 5 is prepared by collecting and sorting the reverse link page ID pointed from the same page ID in Table 4 by the reverse link, and disposing the page ID in a row of reverse link page ID list.

Moreover, when the URL of the Web page as the analysis object is designated, the URL pointed from the Web page indicated by the URL by the reverse link is obtained as a designation of the related page, and the list 3 is generated (S1). Concretely, the list 3 is generated by the following operation.

The operation comprises first utilizing the URL-page ID conversion table of Table 2 to convert the designated URL to the page ID, and utilizing the reverse link page ID list table of Table 5 to obtain the reverse link page ID list corresponding to the page ID. Subsequently, the URL-page ID conversion table of Table 2 is utilized to convert the reverse link page ID list to the URL list 3.

Every time the audience browses the Web page, the access log is collected.

FIG. 5 is a block diagram showing a constitution example of an access log collection system. FIG. 5 shows an example in which a panel member accesses a Web server 13 by a personal computer (PC) 12.

A browser software 14 is installed in the PC 12 of the panel member. The panel member accesses the Web server 13 via Internet, and browses the Web page opened to the public on WWW.

An audience rating surveyor recruits the panel members who cooperate in an audience rating survey, so that an information collection software 15 is installed in the PC 12 used by the panel member. Thereby, the special information collection software 15 is added to the Web browser 14 of the PC 12.

Moreover, the audience rating surveyor manages each panel member by ID number via the access information totaling server 5, and registers characteristic information concerning the panel member beforehand.

Table 6 shows an example of the characteristic information concerning the panel member.

TABLE 6

| Characteristic | |
|---|---|
| data item | Obtainable value |
| Panel member ID | ID number |
| number | |
| Sex | Male, female |
| Age group | up to 20, 20 to 30, 30 |
| | to 40, 40 to 50, 50 to |
| | 60, from 60 |
| Family member | Unmarried, married with |
| | no children, married |
| | with children |
| Job type | Self-employed, engineer, |
| | manager, specialist |
| Residence | Administrative division |
| division | |
| Annual income | up to 4, 6, 8, 10 |
| | millions, exceeding 10 |
| | millions |
| Hobby | Sports, journey, |
| | drinking and eating, |
| | movie, shopping |

The information collection software 15 notifies the access information totaling server 5 of an accessed URL notification message, every time the browser 14 browses a new Web page.

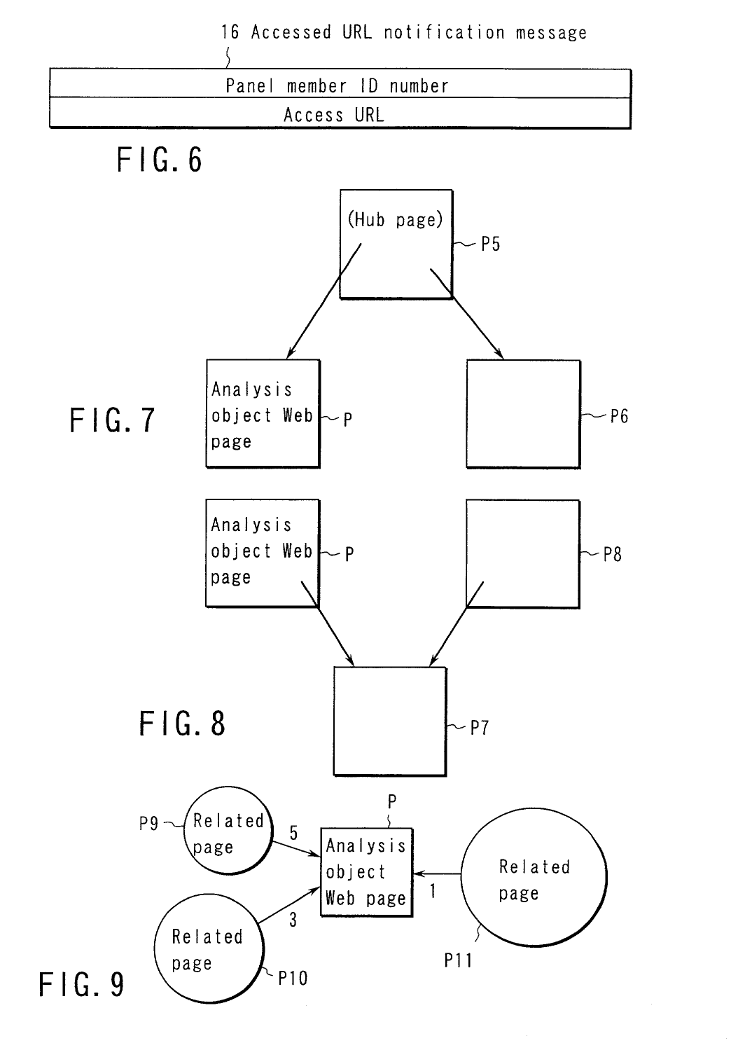

FIG. 6 is a diagram showing an constitution example of the accessed URL notification message. An accessed URL notification message 16 includes a panel member ID number and accessed Web page URL.

The access information totaling server 5 receives the accessed URL notification message 16 from a plurality of panel member PCs 12, and stores a message content as the access log in the access information database 5a.

Table 7 is a table showing examples of the access log. The access log is processed from various viewpoints by the access information totaling server 5. For example, the number of accesses for a given period are totaled for each Web page. A Web page audience rating is calculated based on the totaled value.

TABLE 7

| | Panel member | |
|---|---|---|
| Time | ID number | Accessed URL |
| 18:56:45 June | 001001 | www.page1.co.jp |
| 27, 2000 | | |
| 18:57:01 June | 002334 | www.page101.co.jp |
| 27, 2000 | | |
| 18:57:13 June | 035284 | www.page20.co.jp |
| 27, 2000 | | |
| 18:58:02 June | 087743 | www.page44.co.jp |
| 27, 2000 | | |

When the list 3 designating the related page with respect to the Web page as the analysis object is acquired (S2), the access information totaling server 5 acquires the audience information 7 for each related page designated in the list 3 (S3), and the analysis processing of the audience information 7 concerning the related page is executed (S4). An example of the analysis processing will be described hereinafter.

For example, a line indicating that any related page is accessed for a given period is extracted from the access log of Table 7, and the ID number of the panel member is acquired.

Table 8 is an ID list of the panel member having accessed any related page for the given period.

TABLE 8
Panel member ID number
035284
001001
002334
001001

Table 9 is a table showing examples of the panel member ID number and the number of accesses to the related page by the panel member.

TABLE 9

| Panel member ID | |
|---|---|
| number | Number of accesses |
| 001001 | 2 |
| 002334 | 1 |
| 035284 | 1 |

Table 9 is prepared by sorting the panel member ID numbers of Table 8, counting the number of respective panel member ID numbers, gathering the same panel member ID number, and disposing the counted number in a row of the number of accesses.

The analysis processing comprises utilizing the panel member ID number and the number of accesses of Table 9 and the sex information concerning the panel member of Table 6 to represent numeric values “1” for male and “0” for female, adding the values by the number of accesses, and obtaining an average. The result is a weighted male/female ratio.

When the weighted male/female ratio is larger than 0.5, more males access the related page than female as a result.

Moreover, the calculated value of the weighted male ratio with respect to the whole access log of Table 7 is compared with the weighted male ratio of the related page, and the latter weighted male ratio is statically larger by a significant degree. As a result, the related page has a higher ratio of browsing by males as compared with the general Web page.

Furthermore, various aforementioned characteristic analyses may be performed in time series. For example, when the weighted male/female ratio is obtained and observed every month, an increase/decrease state can be grasped.

Additionally, not only the sex but also the age, annual income, residence district, and other characteristics may be analyzed, and the audience characteristic of the related page may be obtained.

An assumption that the audience characteristic of the related page is similar to the characteristic of the person having actually browsed the Web page as the analysis object is established. Because, those who access the Web pages related to one another have some common characteristics in many cases.

Particularly, when the related page is defined based on the reverse link like in the first embodiment, the assumption that the characteristics of the audiences of both pages are similar to each other can be supported by a “random walk” model.

The “random walk” model shows a transiting way of the Web page audience between the Web pages. This model is a hypothesis concerning a browsing pattern of the audience. In a concrete example of the “random walk” model, a person now browsing a certain Web page will next browse any page of a group of Web pages to which the hyperlink is extended directly from the Web page being browsed in many cases, and sometimes jump to a separate page.

Therefore, an assumption that the audience of the linker Web page has a characteristic similar to that of the audience of the linked Web page.

Even when it is difficult to statistically process the panel member characteristics because of a small number of panel members having browsed the Web page as the analysis object, the audience characteristics of the related page having a sufficiently large number of panel members having browsed the page can be obtained by statistical analysis. Moreover, the audience characteristic of the related page can be used as an estimated value of the audience characteristic of the Web page as the analysis object.

A page connected directly to the Web page as the analysis object via the reverse link is a one hop reverse link page, but the reverse link by two or more hops to the Web page as the analysis object may be a related page. Additionally, the audience of the related page with a smaller number of hops of the link for connecting the Web pages to each other is more similar in characteristic to the audience of the Web page as the analysis object.

One concrete use example of the Web audience analysis system 1 according to the first embodiment will be described hereinafter.

For example, when the female ratio of the related page audience is overwhelmingly high, an EC agent utilizing the Web page to help the audience to find an accommodation can improve the page in order to increase the number of handled accommodations with conditions of location and outward appearance targeted for females.

Moreover, when a store utilizing the Web page to sell an article utilizes a certain list to send direct mails to people, and when the female ratio of the related page audience is high, the direct mails can be sent to females in a limited manner.

When the characteristic of a business target is appropriately grasped in this manner, advertisement with a high ratio of effect to cost can be realized.

Moreover, even when the number of panel members having browsed the Web page as the analysis object is sufficiently large, and the statistical processing is possible, it is largely advantageous to analyze the audience characteristic of the related page. It can be interpreted that the audience of the related page includes a large number of potential audiences of the Web page as the analysis object. Therefore, when the audience characteristics indicate different results between the Web page as the analysis object and the related page, it can be judged that the audience characteristic of the related page can be a future audience characteristic of the Web page as the analysis object.

For example, it is assumed that a high male ratio continues to be high with respect to the actual audience of a certain Web page, but the female ratio rapidly increases with respect to the audience of the related page. In this case, the female ratio of the Web page is also expected to increase. Therefore, a corporate who utilizes the Web page to sell an article can quickly improve the page in such a manner that more female's favorite articles are displayed on the page.

Moreover, when a corporate predicts an increase of the female ratio of the Web page audience, and carries out a questionnaire survey of the handled article, a questionnaire survey mainly of females can be performed. Thereby, a consciousness survey of females having an increasing ratio in future can be conducted beforehand, and the result can directly be associated with an article improvement.

In the aforementioned Web audience analysis system 1 according to the first embodiment, the analysis processing is executed based on the audience information concerning the related page.

Therefore, even when the Web page as the analysis object does not have a sufficient number of panel audiences for the analysis processing, an effective analysis result concerning the Web page as the analysis object can be obtained. Then, since even the Web page having a small number of audiences can be subjected to the analysis processing, the number of Web pages able to be subjected to the analysis processing and evaluated/improved can be increased.

Moreover, when the related page audience is analyzed, the potential audience characteristic of the Web page as the analysis object can be obtained. For example, a change of the potential audience with an elapse of time is observed so that a probable change of the Web page as the analysis object can be predicted.

Therefore, the Web page can be evaluated/improved, and a high-quality marketing in EC can be performed.

Additionally, the analyzing technique described in the first embodiment is not limited to the utilization for the marketing in EC. For example, the technique can be applied to a case in which an advertisement is run on the Web page and the number of Web page audiences is desired to increase, or can also be applied in order to grasp the Web page audience characteristic. That is, when the first embodiment is applied to analyze the Web page, the audience characteristic is known in any Web page commercial utilization, and the content suitable for the audience can be provided.

Moreover, the Web page assembly having the same attribute (field, theme, Web page possessor job type, article type displayed in the Web page, and the like) as that of the Web page assembly as the analysis object may be used as the Web page assembly related to the Web page assembly as the analysis object. Additionally, a Web page assembly including more than a set standard amount of or a large ratio of words and synonyms common with those of the Web page assembly as the analysis object, a Web page assembly having the same keyword, and the like may be a Web page assembly related to the Web page assembly as the analysis object.

Moreover, the analysis processor 9 may utilize the audience information and other information with respect to the Web page assembly related to the Web page assembly as the analysis object to execute the analysis processing. For example, the audience information of not only the related Web page assembly but also the Web page assembly as the analysis object may be subjected to the analysis processing. Moreover, the analysis result of the related Web page assembly may be compared with the analysis result of another Web page assembly, or the analysis result of the related Web page assembly may be compared with the analysis result of the whole Web page assembly by the analysis processing.

Moreover, the related information may include the designation of the Web page assembly as the analysis object.

(Second Embodiment)

In a second embodiment, a modification example of the first embodiment will be described.

In the Web audience information analysis system 1 described in the first embodiment, the related information generator 2, access information totaling server 5, and access information database 5a are separately constituted, but the related information generator 2, access information totaling server 5, and access information database 5a may be added to elements constituting the Web audience information analysis system.

Moreover, as shown in FIG. 7, a Web page P6 having a linker common with that of the analysis object Web page P may be the related page. That is Because a common property tends to exist between the Web pages having the common linker. A Web page P5 as a common linker of a plurality of Web pages P, P6 is a hub page. In this analysis technique, the number of hub pages can be plural.

Moreover, as shown in FIG. 8, a linked Web page P7 with a link extended from the analysis object Web page P may be the related page. Furthermore, another Web page P8 with a link extended to the linked Web page P7 may be the related page. In this analysis technique, the number of linked pages can be plural.

Furthermore, the analysis processing may be weighted by a relation strength between the Web page as the analysis object and the related page, and performed. For example, with a high male ratio in the linker Web page having a large number of links extended to the Web page as the analysis object, analysis is performed so that the male ratio is increased in the evaluation information of the Web page as the analysis object. Additionally, when the number of reverse link hops is small, the number or ratio of common characters in the page is large, the pages are similarly well-known in the field, or the pages closely resemble each other in a business scale, the pages are judged to have a strong relation, and a weight in the analysis may be increased.

(Third Embodiment)

In a third embodiment, referrer information included in the access log obtained on the Web server is utilized in generating related information.

Table 10 shows an example of the access log recorded in the Web server which holds the Web page as the analysis object.

TABLE 10
Access log of web server

| | Terminal IP | | |
|---|---|---|---|
| Time (sec) | address | Access URL | Referrer (url) |
| 2001/02/05/ | 133.113.214.51 | index.html | www.aaa.co.jp/car/shop_list.html |
| 16:23:20 | | | |
| 2001/02/05/ | 133.114.81.56 | location/access.html | www.bbb.co.jp/shops/map.html |
| 16:25:30 | | | |
| 2001/02/05/ | 140.35.84.21 | index.html | www.ccc.co.jp/bike/shops.html |
| 16:33:45 | | | |
| 2001/02/05/ | 152.211.102.45 | services/list.html | NULL |
| 16:36:41 | | | |
| 2001/02/05/ | 160.134.29.49 | members/main.html | NULL |
| 16:41:50 | | | |
| 2001/02/05/ | 165.32.133.41 | index.html | www.aaa.co.jp/car/shop_list.html |
| 16:42:12 | | | |

The Web server is set so that an access time, IP address of an accessing terminal (browser), accessed Web page URL, and referrer information are recorded for each access by one record.

Here, the referrer information is a linker URL in a case in which the link is utilized to access the Web page. For example, it is assumed, the link is extended to the Web page as the analysis object “index.html” from another Web page “www.aaa.co.jp/car/shop list.html”. In a first line of Table 10, the referrer information indicating that link from this Web page was utilized to access the Web page as the analysis object is recorded.

When the related page is extracted in the third embodiment, first the access log obtained from the Web server access log for the given period is selected. Subsequently, a record indicating that the Web page as the analysis object is accessed from the selected access log is selected. Moreover, the Web page indicated by the referrer information included in the selected record is regarded as the related page.

The “random walk” model shows that the Web page audience tends to trace the hyperlink from the Web page being browsed and browse another Web page.

Therefore, a probability that the audience of the related page extracted based on the referrer information browses the Web page as the analysis object is expected to be higher than a probability that the audience of the Web page other than the related page browses the Web page as the analysis object.

A concrete method of extracting the related page based on the referrer information will be described hereinafter.

When the analysis object Web page is “index.html”, the referrer information of the record with an access URL “index.html” is extracted from Table 10.

Subsequently, a frequency of the extracted referrer information is counted, and redundancy is removed.

Table 11 shows an example of a relation between the extracted referrer information and the frequency.

TABLE 11
Extracted referrer information
and frequency

| | Referrer |
|---|---|
| Referrer (URL) | frequency |
| www.aaa.co.jp/car/shop_list.html | 2 |
| www.ccc.co.jp/bike/shops.html | 1 |

Subsequently, related information is generated in such a manner that the Web page indicated by the extracted referrer information is regarded as the related page, and the information is weighted by the referrer information frequency in the analysis processing.

A concrete example of the analysis processing based on the referrer information will be described hereinafter.

Table 12 shows the ID number of the panel member having accessed “www.aaa.co.jp/car/shop_list.html” as the related page and the number of accesses by the panel member. Table 12 is prepared based on the above Table 7.

TABLE 12
Panel member having
accessed related page and the number
of_accesses

| Panel member ID | |
|---|---|
| number | Number of accesses |
| 023211 | 2 |
| 356451 | 1 |

That is, the panel member shown in Table 12 accesses the related page by a frequency indicated by the number of accesses in the given period.

In the analysis processing, the characteristic information of the panel member shown in Table 12 is weighted by the number of accesses.

For example, when the male/female ratio is calculated, the male/female ratio weighted for each related page by the number of accesses is calculated.

Table 13 shows the result.

TABLE 13
Analysis result of related page
weighted by number of accesses

| | Weighted |
|---|---|
| | male/ |
| | female |
| Referrer (URL) | ratio |
| www.aaa.co.jp/car/shop_list.html | 0.31 |
| www.ccc.co.jp/bike/shops.html | 0.42 |

In the analysis processing, a “weighted male/female ratio” of Table 13 is further weighted by a referrer frequency of Table 11, and a weighted average may be obtained.

FIG. 9 is an explanatory view of weighting by a frequency of referrer information.

It is assumed that related pages P9 to P11 are extracted with respect to the analysis object Web page P based on the referrer information. A numeric value attached to an arrow in FIG. 9 is the referrer frequency.

A size of a circle representing the related pages P9 to P11 schematically represents the number of accesses of the related page.

When the weighting is based on the number of accesses of the related pages P9 to P11 as a standard, the characteristic information of the panel member having accessed each related page is reflected in the analysis result in order of the related pages P11, P10, and P9. This manner of calculation is equivalent to the way of calculation wherein the average male/female ratio is obtained being weighted simply by the number of accesses for each audience who has accessed any of P9, P10, and P11 without considering the referrer frequency.

On the other hand, when the weighting is based on the referrer frequency attached to the arrow, the characteristic information of the panel member having accessed each related page is reflected in the analysis result in order of the related pages P9, P10, and P11.

An effect of utilization of the referrer information will be described hereinafter.

The related page P11 is accessed by a large number of audiences, but the analysis object Web page P is more frequently browsed via the related page P9. Therefore, when the characteristic of the potential audience is estimated, the referrer frequency can be used as a weighting factor to analyze the characteristic with a higher precision.

As described above, the weighting can be performed with various factors in the analysis processing. However, when the referrer information is utilized, the weighting is performed based on a utilization frequency of a channel traced by the audience actually having accessed the analysis object Web page. Therefore, the characteristic of a population of the potential audience can be estimated with a high precision.

Moreover, when the referrer information is utilized, the related page can be obtained at a cost and investigation less than those of other techniques described in the earlier part of this invention for extracting related pages.

This is because the related page can be obtained only by analyzing the access log stored in the Web server with the analysis object Web page held therein. For example, when link information is collected to extract the related page, systems for automatically collecting a large number of Web pages from Internet, such as the aforementioned crawler are necessary.

Moreover, even when the audience traces the link from the dynamically generated Web page to browse the analysis object Web page, the referrer information can be utilized to extract the linker Web page as the related page. For example, even when a search result in the Web page having a search function is utilized to access the analysis object Web page, the Web page having the search function can be extracted as the related page.

Furthermore, the referrer information can be utilized to easily extract the Web page which temporarily serves as the linker of the analysis object Web page as the related page.

For example, a content of a news page is frequently updated. When the referrer information is utilized, and the link is traced to access the analysis object Web page, even the frequently updated page can be extracted as the related page. When the crawler is utilized, in order to obtain the content of the frequently updated page, it is necessary to very frequently repeat the automatic collection of the Web page, and this requires much cost.

Additionally, User identifying, IP address information of the terminal included in the access log of the Web server, cookie, and the like are utilized to obtain the number of accesses, while a plurality of accesses by the same user, the same terminal, or the same browser are aggregated as one access. The analysis may also be performed in this manner.

(Fourth Embodiment)

When the related information generator 2, related information acquiring section 4, access information totaling server 5, audience information acquiring section 6, analysis processor 9, and output section 11 can realize the similar action/function, arrangement of respective constituting elements may be changed, the respective constituting elements may optionally be combined, or each constituting element may be divided.

Moreover, the respective constituting elements 2, 4 to 6, 9, and 11 described in the aforementioned respective embodiments may be written into recording media such as a magnetic disk (flexible disk, hard disk, and the like), optical disk (CD-ROM, DVD, and the like), and semiconductor memory, and applied to a computer. Furthermore, such program may also be transmitted via a communication medium and applied to the computer.

The computer for realizing the aforementioned respective functions reads the program recorded in the recording medium, controls an operation by the program, and executes the aforementioned processing.

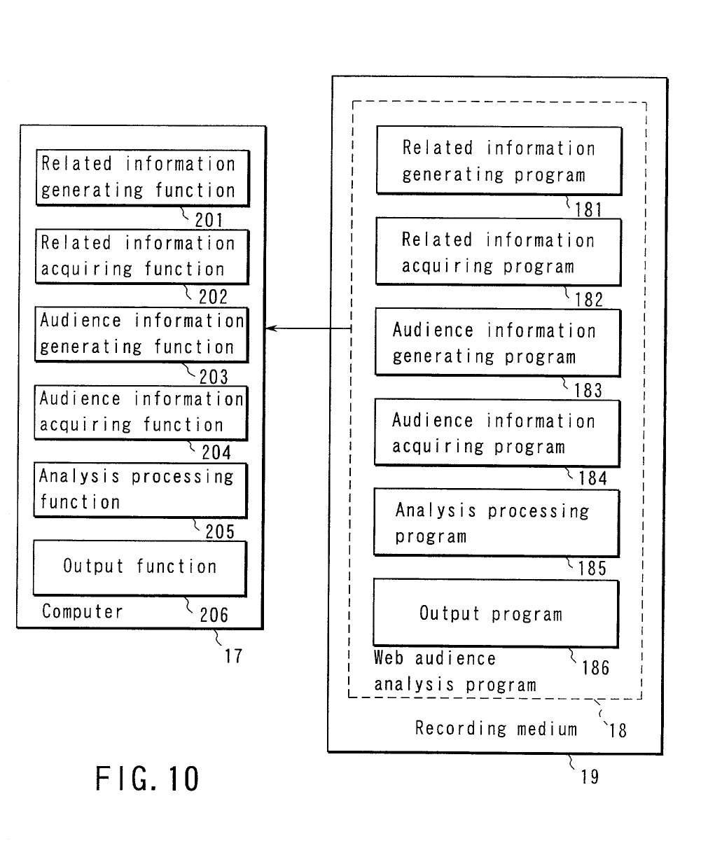

FIG. 10 shows a recording medium 19 in which a Web audience analysis program 18 for realizing functions similar to those of the constituting elements 2, 4 to 6, 9, 11 by a computer 17 is recorded.

When a related information generating program 181 included in the Web audience analysis program 18 is executed, a related information generating function 201 for performing a processing similar to that of the related information generator 2 is realized.

When a related information acquiring program 182 is executed, a related information acquiring function 202 for performing the processing similar to that of the related information acquiring section 4 is realized.

When an audience information generating program 183 is executed, an audience information generating function 203 for performing the processing similar to that of the access information totaling server 5 is realized.

Moreover, an audience information acquiring program 184, analysis processing program 185, and output program 186 are also similarly executed.

(Fifth Embodiment)

In a fifth embodiment, a Web audience analysis service will be described.

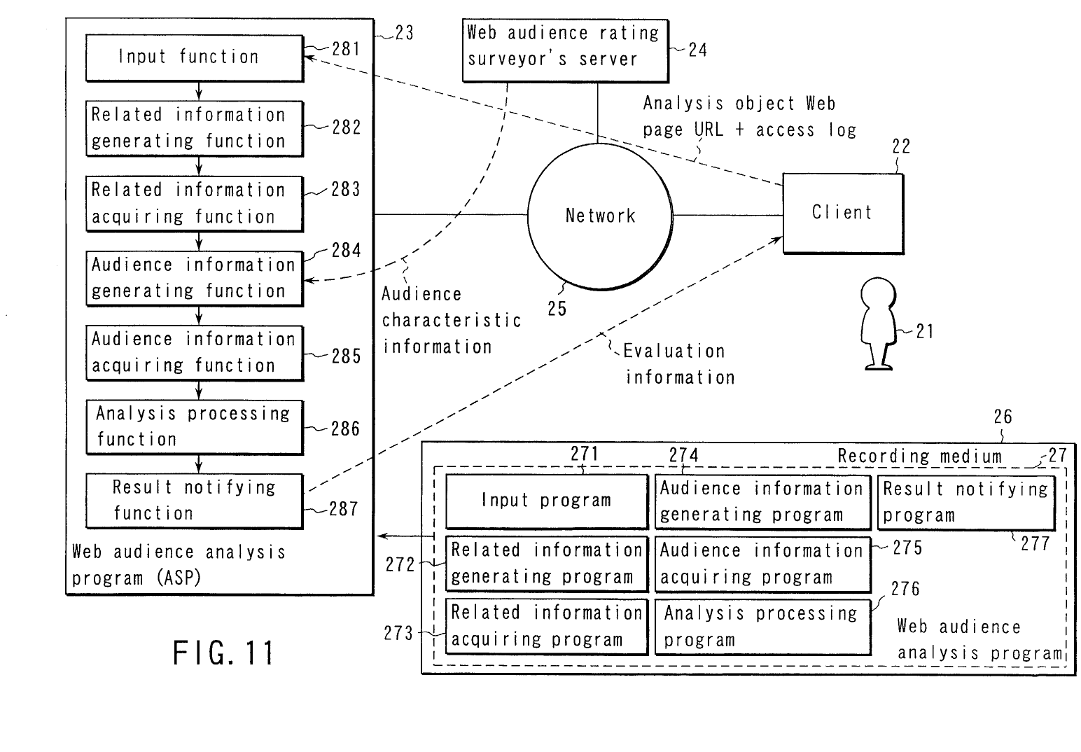

FIG. 11 is a block diagram showing a service providing state by the Web audience analysis system according to the fifth embodiment.

A client 22 operated by a user 21, Web audience analysis system 23 managed by an application service provider (ASP), and Web audience rating surveyor 24 are connected via a network 25 such as Internet so that mutual transmission/reception is possible.

The Web audience analysis system 23 reads a Web audience analysis program 27 recorded in a recording medium 26. Moreover, the Web audience analysis system 23 executes respective programs included in the Web audience analysis program 27, and executes respective functions 281 to 287.

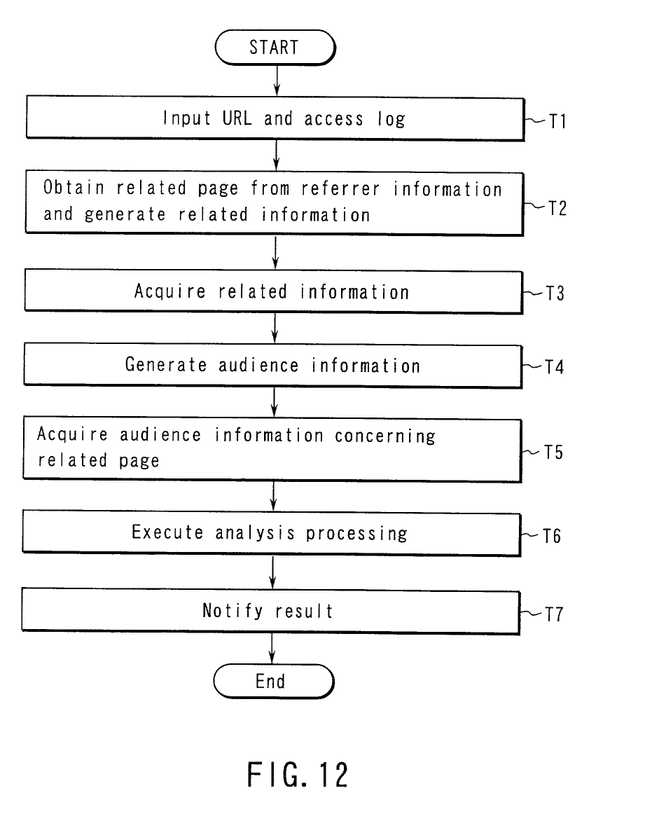

FIG. 12 is a flowchart showing a processing executed by the Web audience analysis system 23.

First, the input function 281 of the Web audience analysis system 23 inputs URL of the analysis object Web page and the access log of the Web page from the client 22 operated by the user 21 via the network 25 (T1).

Subsequently, the related information generating function 282 extracts the related page from the referrer information included in the access log, and generates the related information (T2). The generated related information is acquired by the related information acquiring function 283 (T3).

Subsequently, the audience information generating function 284 extracts the panel member characteristic information stored in the Web audience rating surveyor serer 24, and generates the audience information (T4).

Subsequently, the audience information acquiring function 285 acquires the audience information concerning the related page (T5).

Next, the analysis processing function 286 executes the analysis processing based on the audience information concerning the related page (T6).

Subsequently, the result notifying function 287 transmits an analysis result as evaluation information of the analysis object Web page to the client 22 via the network 25 (T7). The analysis result may be transmitted as a graph data file or a table data file attached to an electronic mail to the user 21. Moreover, the user 21 may access the Web audience analysis system, acquire the analysis result via the browser, and display the result.

Additionally, in the processing executed by the Web audience analysis system 23, a timing for generating the related information and audience information is not limited to the aforementioned timing, and each information may also be generated at an arbitrary timing before the aforementioned timing.

As described above, when the Web audience analysis system 23 of the fifth embodiment is utilized, the audience can effectively analyzed even with a small number of panel members having browsed the analysis object Web page, and the potential audience can also be surveyed.

Moreover, the user can obtain more efficiency in maintenance/operation as compared with the case in which the user itself manages the Web audience analysis system 23 and Web audience analysis program 27.

On the other hand, ASP as a manager of the Web audience analysis system 23 can obtain a consideration from the user 21 by executing the Web audience analysis as an agent for the user.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A Web audience analyzing method for analyzing an audience of a Web page assembly constituted of at least one Web page by a computer, comprising the steps of:
acquiring related information including a designation of a Web page assembly related to the Web page assembly as an analysis object;
acquiring audience information with respect to the Web page assembly designated by said related information; and
executing an analysis processing based on the acquired audience information and acquiring evaluation information concerning said analysis object Web page assembly.

2. The Web audience analyzing method according to claim 1, wherein said related information is generated based on the designation of the Web page assembly which is related to said analysis object Web page assembly and selected from Web page assemblies present on a network.

3. The Web audience analyzing method according to claim 1, wherein said audience information is generated based on characteristic information of the audience, and a record of the Web page assembly browsed by the audience.

4. The Web audience analyzing method according to claim 1, wherein said related information includes the designation of the Web page assembly linked with said analysis object Web page assembly in a predetermined relation.

5. The Web audience analyzing method according to claim 4, wherein said related information includes the designation of the Web page assembly as a linker of said analysis object Web page assembly.

6. The Web audience analyzing method according to claim 4, wherein said related information includes the designation of the Web page assembly having a linker common with the linker of said analysis object Web page assembly.

7. The Web audience analyzing method according to claim 1, wherein said related information is generated based on the designation of the Web page assembly obtained as a linker of said analysis object Web page assembly by processing referrer information indicating the linker of a Web page accessed utilizing a link.

8. The Web audience analyzing method according to claim 7, wherein said analysis processing comprises the steps of: obtaining the number of accesses utilizing a link to said analysis object Web page assembly from the Web page assembly designated by said related information for each Web page assembly designated by said related information by processing said referrer information; and weighting the audience information acquired in accordance with the number of accesses.

9. The Web audience analyzing method according to claim 7, wherein said analysis processing comprises the steps of: obtaining the number of users having utilized a link to said analysis object Web page assembly from the Web page assembly designated by said related information for each Web page assembly designated by said related information based on user identifying information transmitted from a terminal of the user having accessed a Web server, and said referrer information; and weighting the audience information acquired in accordance with the number of users.

10. A Web audience analyzing method for analyzing an audience of a Web page assembly constituted of at least one Web page by a computer, comprising the steps of:
inputting a designation of a Web page assembly as an analysis object;
acquiring related information including a designation of a Web page assembly related to said analysis object Web page assembly based on the designation of said analysis object Web page assembly;
acquiring audience information with respect to the Web page assembly designated by said related information;
executing an analysis processing based on the acquired audience information; and
providing evaluation information concerning said analysis object Web page assembly as a result of said analysis processing.

11. The Web audience analyzing method according to claim 10, wherein the designation of the analysis object Web page assembly is inputted via a network.

12. The Web audience analyzing method according to claim 10, wherein the evaluation information is provided via a network.

13. A computer readable computer program product for analyzing an audience of a Web page assembly constituted of at least one Web page, said program product comprising:
a first code that acquires related information including a designation of a Web page assembly related to a Web page assembly as an analysis object;
a second code that acquires audience information with respect to the Web page assembly designated by said related information; and
a third code that executes an analysis processing based on the acquired audience information and obtains evaluation information concerning said analysis object Web page assembly.

14. The computer program product according to claim 13, further comprising a code that selects the Web page assembly related to said analysis object Web page assembly from Web page assemblies on a network and generates said related information.

15. The computer program product according to claim 13, further comprising a code that generates said audience information based on characteristic information of the audience, and a record of the Web page assembly browsed by the audience.

16. The computer program product according to claim 13, wherein said related information includes the designation of the Web page assembly linked with said analysis object Web page assembly in a predetermined relation.

17. The computer program product according to claim 16, wherein said related information includes the designation of the Web page assembly as a linker of said analysis object Web page assembly.

18. The computer program product according to claim 16, wherein said related information includes the designation of the Web page assembly having a linker common with the linker of said analysis object Web page assembly.

19. The computer program product according to claim 13, wherein said related information is generated based on the designation of the Web page assembly obtained as a linker of said analysis object Web page assembly by processing referrer information indicating the linker of a Web page accessed utilizing a link.

20. The computer program product according to claim 19, wherein said analysis processing comprises the steps of: obtaining the number of accesses utilizing a link to said analysis object Web page assembly from the Web page assembly designated by said related information for each Web page assembly designated by said related information by processing said referrer information; and weighting the audience information acquired in accordance with the number of accesses.

21. The computer program product according to claim 19, wherein said analysis processing comprises the steps of: obtaining the number of users having utilized a link to said analysis object Web page assembly from the Web page assembly designated by said related information for each Web page assembly designated by said related information based on user identifying information transmitted from a terminal of the user having accessed a Web server, and said referrer information; and weighting the audience information acquired in accordance with the number of users.

22. A computer readable computer program product for analyzing an audience of a Web page assembly constituted at least one Web page, said program product comprising:
a first code that inputs a designation of a Web page assembly as an analysis object;
a second code that acquires related information including a designation of a Web page assembly related to said analysis object Web page assembly based on the inputted designation of the analysis object Web page assembly;
a third code that acquires audience information with respect to the Web page assembly designated by the acquired related information;
a fourth code that executes an analysis processing based on the acquired audience information; and
a fifth code that provides evaluation information concerning said analysis object Web page assembly as a result of said analysis processing.

23. The computer program product according to claim 22, wherein the designation of the analysis object Web page assembly is inputted via a network.

24. The computer program product according to claim 22, wherein the evaluation information is provided via a network.

25. A Web audience analysis system for analyzing an audience of a Web page assembly constituted of at least one Web page, said system comprising:
a related information acquiring section that acquires related information including a designation of at least one Web page assembly related to the Web page assembly as an analysis object;
an audience information acquiring section that acquires audience information with respect to the Web page assembly designated by the related information acquired by said related information acquiring section; and
an analysis processor that executes an analysis processing based on the audience information acquired by said audience information acquiring section and obtains evaluation information concerning said analysis object Web page assembly.

26. A Web audience analysis system for analyzing an audience of a Web page assembly constituted of at least one Web page, said system comprising:
an input section that inputs a designation of the Web page assembly as an analysis object;
a related information acquiring section that acquires related information including a designation of a Web page assembly related to said analysis object Web page assembly based on the designation of the analysis object Web page assembly inputted by said input section;
an audience information acquiring section that acquires audience information with respect to the Web page assembly designated by the related information acquired by said related information acquiring section;
an analysis processor that executes an analysis processing based on the audience information acquired by said audience information acquiring section; and
a result notifying section that provides evaluation information concerning said analysis object Web page assembly as a result of the analysis processing by said analysis processor.
